(19) United States
(12) Patent Application Publication
(10) Pub. No.: US 2019/0188443 A1
(43) Pub. Date: Jun. 20, 2019

(54) INFORMATION PROCESSING APPARATUS, BIOMETRIC AUTHENTICATION METHOD, AND RECORDING MEDIUM HAVING RECORDED THEREON BIOMETRIC AUTHENTICATION PROGRAM

(71) Applicant: FUJITSU LIMITED, Kawasaki-shi (JP)

(72) Inventor: Tomoaki Matsunami, Kawasaki (JP)

(73) Assignee: FUJITSU LIMITED, Kawasaki-shi (JP)

(21) Appl. No.: 16/199,650

(22) Filed: Nov. 26, 2018

(30) Foreign Application Priority Data
Dec. 15, 2017 (JP) 2017-241029

(51) Int. Cl. G06K 9/00; G06K 9/03

(52) U.S. Cl. CPC G06K 9/0008; G06K 9/001; G06K 9/036

(57) ABSTRACT

An information processing apparatus includes a memory and a processor configured to store registered feature information of a first biometric image which is acquired from a registrant, divide a second biometric image which is acquired from an authentication subject into areas, calculate a clarity level indicating a clarity of an image of each of the areas, set, among the areas, at least part of a first area that is an area with the clarity level less than a first threshold, as a mask area, in accordance with the clarity level of each of the areas, generate a corrected biometric image by correcting an image of a second area other than the mask area among the areas; extract feature information from the corrected biometric image, and compare the registered feature information and the extracted feature information to perform authentication for the authentication subject.

### CROSS-REFERENCE TO RELATED APPLICATION

This application is based upon and claims the benefit of priority of the prior Japanese Patent Application No. 2017-241029, filed on Dec. 15, 2017, the entire contents of which are incorporated herein by reference.

### FIELD

The embodiments discussed herein are related to an information processing apparatus, a biometric authentication method, and a recording medium having recorded thereon a biometric authentication program.

### BACKGROUND

Fingerprint authentication, one type of biometric authentication, is used in a wide range of fields, such as control of access to buildings, rooms, or the like, personal computer (PC) access control, and unlocking of smart phones.

Related techniques are disclosed in International Publication Pamphlet No. WO 2005/86091, Japanese Laid-open Patent Publication No. 2003-337949, Japanese Laid-open Patent Publication No. 03-291776, Japanese Laid-open Patent Publication No. 2005-141453, or International Publication Pamphlet No. WO 2013/027572.

### SUMMARY

According to an aspect of the embodiments, an information processing apparatus includes: a memory; and a processor coupled to the memory and configured to: store registered feature information of a first biometric image which is acquired from a registrant; divide a second biometric image which is acquired from an authentication subject into a plurality of areas; calculate a clarity level indicating a clarity of an image of each of the plurality of areas; set, among the plurality of areas, at least part of a first area that is an area with the clarity level less than a first threshold, as a mask area, in accordance with the clarity level of each of the plurality of areas; generate a corrected biometric image by correcting an image of a second area other than the mask area among the plurality of areas; extract feature information from the corrected biometric image; and compare the registered feature information and the extracted feature information to perform authentication for the authentication subject.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of a clear fingerprint;

FIG. 2 illustrates an example of an unclear fingerprint;

FIG. 3 illustrates an example of a biometric authentication apparatus;

FIG. 4 illustrates an example of a biometric authentication process;

FIG. 5 illustrates an example of a fingerprint image;

FIG. 6 illustrates an example of a fingerprint image divided into a plurality of subregions;

FIG. 7 illustrates an example of a determination result for clarity of each subregion;

FIG. 8 illustrates an example of a clarified-ridge fingerprint image and mask areas;

FIG. 9 illustrates an example of a corrected fingerprint image; and

FIG. 10 illustrates an example of an information processing apparatus (computer).

### DESCRIPTION OF EMBODIMENTS

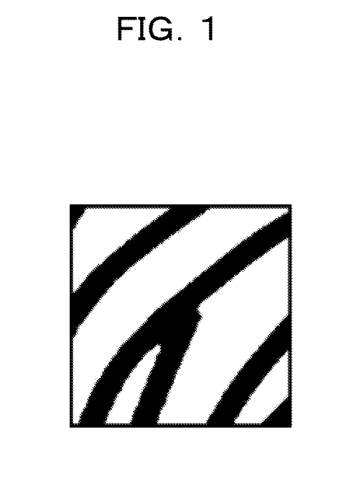

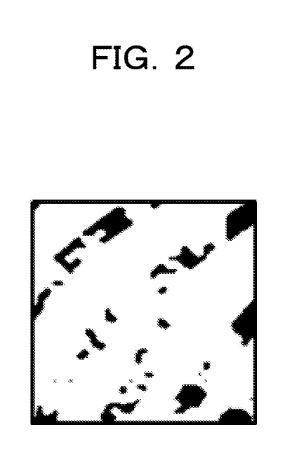

When fingerprint authentication is performed, it is desirable to use a fingerprint image including a clear fingerprint as illustrated in FIG. 1. However, in some cases, the state of the finger surface changes because of drying of fingertips, a change with passage of time, an injury, or the like and thus a fingerprint image where the fingerprint is unclear, as illustrated in FIG. 2, is acquired.

In fingerprint images where the fingerprint is unclear, in some cases, minutiae of the fingerprint for identifying an individual are lost or false minutiae occur, which causes a decrease in the accuracy of authentication. To improve the situation where a decrease in the authentication accuracy is caused, a process for correcting the geometry of a fingerprint is applied to a fingerprint image. Therefore, the reproducibility of minutiae of a fingerprint improves and the accuracy of authentication is enhanced.

Even when shades of gray other than a fingerprint or a palm print are present on the background, the area with the fingerprint or the palm print is precisely determined.

In a correction process for a fingerprint image, image processing is applied to correct the geometry of fingerprint ridges. For example, in an area where the fingerprint is unclear, frequency information and ridge-orientation information that are used in performing correction are often not acquired with certainty. As a result, ridges are enhanced in a false orientation in a correction process to cause the occurrence of minutiae that are not present in the original fingerprint (false minutiae). Therefore, authentication accuracy decreases in some cases due to a fingerprint image that includes false minutiae being used in a comparison process.

The above situation occurs not only when biometric authentication is performed by using a fingerprint image but also when biometric authentication is performed by using another biometric image.

For example, techniques to improve authentication accuracy in biometric authentication may be provided.

Registration information in fingerprint authentication techniques includes ridge orientations, positional relationships of fingerprint minutiae, frequency information, and the like that are digitized, and thus it is difficult to restore the registration information to the original fingerprint image. Therefore, it is difficult to perform a correction process for registration information. For example, when a correction process is performed after registration information has already been generated, the correction process is applied only to a fingerprint image for use during a comparison process. The fingerprint image to which the correction process is applied is compared with registration information generated from a fingerprint image without correction. There is therefore a possibility that authentication accuracy will decrease. This may occur in the case where, in a client/server fingerprint authentication system, the techniques described in International Publication Pamphlet No. WO 2005/86091, Japanese Laid-open Patent Publication No. 2003-337949, Japanese Laid-open Patent Publication No. 03-291776, Japanese Laid-open Patent Publication No. 2005-141453, or International Publication Pamphlet No. WO 2013/027572 are applied after a registrant has completed registration. In order to reduce the decrease in authentication accuracy, it is desirable to cause a registrant to perform reregistration to regenerate registration information from a fingerprint to which a correction process has been applied. However, implementation of a reregistration process for an enormous number of registrants is a very large burden and is not practical.

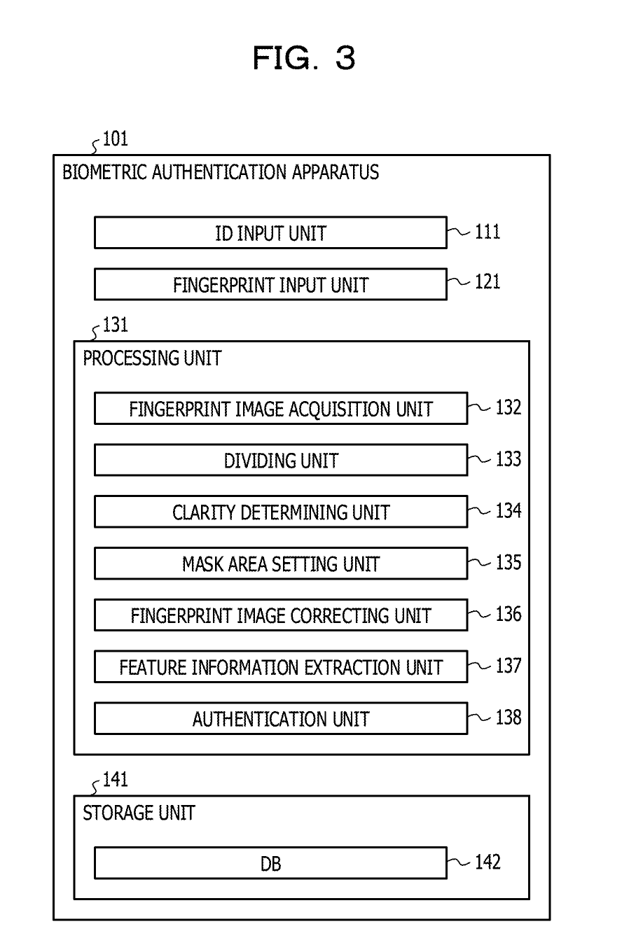

FIG. 3 illustrates an example of a biometric authentication apparatus. A biometric authentication apparatus 101 includes an identifier (ID) input unit 111, a fingerprint input unit 121, a processing unit 131, and a storage unit 141. The processing unit 131 includes a fingerprint image acquisition unit 132, a dividing unit 133, a clarity determining unit 134, a mask area setting unit 135, a fingerprint image correcting unit 136, a feature information extraction unit 137, and an authentication unit 138.

The ID input unit 111 acquires an ID input from an authentication subject. The ID is information (identifier) that identifies the authentication subject. The ID input unit 111 is, for example, a keyboard, a touch panel, a magnetic card reader, an integrated circuit (IC) card reader, or the like. For example, when the ID input unit 111 is a keyboard or a touch panel, the ID input unit 111 uses the keyboard or the touch panel to acquire an ID input by an authentication subject. When the ID input unit 111 is a magnetic card reader or an IC card reader, the ID input unit 111 reads the magnetic card reader or the IC card and acquires the ID read from the magnetic card reader or the IC card.

The fingerprint input unit 121 detects unevenness of the surface of a finger of the authentication subject, generates a fingerprint image representing a pattern of ridges (for example, a fingerprint) and outputs the fingerprint image to the fingerprint image acquisition unit 132. The fingerprint input unit 121 is, for example, a fingerprint sensor. The fingerprint image is an example of a biometric image.

The fingerprint image acquisition unit 132 acquires a fingerprint image from the fingerprint input unit 121.

The dividing unit 133 divides the fingerprint image into a plurality of areas. In the embodiment, an area resulting from the division is referred to as a subregion. The dividing unit 133 divides the fingerprint image, for example, such that each of subregions is a rectangular area with a length of 8 pixels and a width of 8 pixels.

The clarity determining unit 134 calculates a clarity level indicating the clarity of an image in each subregion, in particular, the clarity of a fingerprint included in each subregion. The clarity determining unit 134 determines, in accordance with the clarity level, whether each subregion is a clear area, a semi-clear area, or an unclear area. The clarity determining unit 134 is an example of a calculation unit.

Based on a result of determination by the clarity determining unit 134, the mask area setting unit 135 sets a mask area where the fingerprint (in particular, the geometry of ridges) is not corrected. In particular, the mask area setting unit 135 sets, among subregions determined to be unclear areas, at least one or more subregions as the mask areas. Furthermore, the mask area setting unit 135 may set, among subregions determined to be clear areas, at least one or more subregions as the mask areas.

The fingerprint image correcting unit 136 corrects a fingerprint (in particular, the geometry of ridges) included in subregions other than the subregions set as the mask areas and generates a clarified-ridge fingerprint image. The fingerprint image correcting unit 136 combines the fingerprint image with the clarified-edge fingerprint image to generate a corrected fingerprint image. The fingerprint image correcting unit 136 is an example of a correcting unit.

The feature information extraction unit 137 extracts feature information from the corrected fingerprint image. The feature information is, for example, the positions of minutiae, such as a ridge ending, which is a point at which a fingerprint ridge terminates, and a ridge bifurcation, where a single fingerprint ridge splits into two ridges, and the relationships among their respective positions, and the like. The feature information extraction unit 137 is an example of an extraction unit.

The authentication unit 138 compares the feature information of an authentication subject extracted by the feature information extraction unit 137 with the feature information associated with the ID, which is acquired from the ID input unit 111, included in the DB 142 and authenticates the authentication subject.

The storage unit 141 stores therein data, programs, and the like for use in the biometric authentication apparatus 101. The storage unit 141 stores therein a database (DB) 142.

In the DB 142, IDs and feature information are recorded in association with each other. The DB 142 includes a plurality of IDs and a plural pieces of registration information. The ID is information (identifier) that identifies a registrant to the biometric authentication apparatus 101. The feature information indicates features of the fingerprint of a registrant. The feature information is, for example, the positions of minutiae, such as a ridge ending, which is a point at which a fingerprint ridge terminates, and a ridge bifurcation, where a single fingerprint ridge splits into two ridges, and the relationships among their respective positions, and the like. The feature information is extracted from a fingerprint image including a fingerprint acquired from a registrant. For a fingerprint image for use in registering feature information in the DB 142, it is assumed that correction of the fingerprint is not performed.

The configuration of the biometric authentication apparatus 101 described above is exemplary but not limiting. The ID input unit 111, the fingerprint input unit 121, the processing unit 131, and the storage unit 141 or any combinations thereof, for example, are included in different apparatuses, a plurality of which are coupled via a network, and may thereby be configured as a system having functions similar to those of the biometric authentication apparatus 101. For example, the biometric authentication apparatus 101 without including the ID input unit 111 and the fingerprint input unit 121 may receive the ID and a fingerprint image of an authentication subject from the ID input unit 111 and the fingerprint input unit 121 coupled thereto via a network.

The biometric authentication apparatus 101 described above is not limited to one-to-one authentication, which uses an ID input by an authentication subject in performing a biometric authentication process to identify feature information to be compared, and may perform one-to-N authentication, which does not acquire an ID from an authentication subject but compares feature information acquired from the authentication subject with plural pieces of feature information in the DB 142.

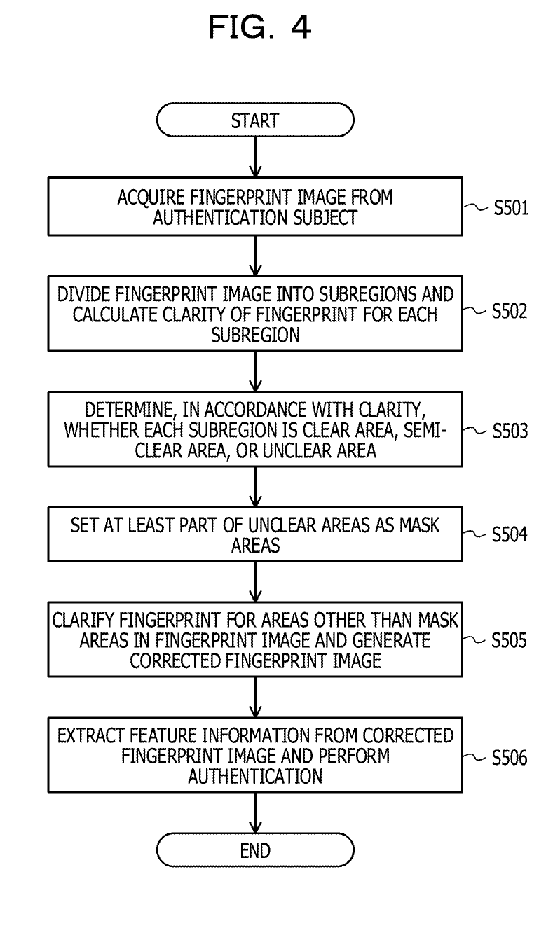

FIG. 4 illustrates an example of a biometric authentication process.

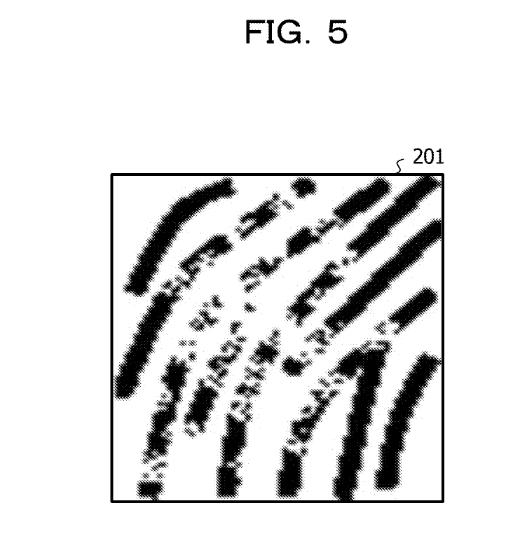

FIG. 5 is an example of a fingerprint image.

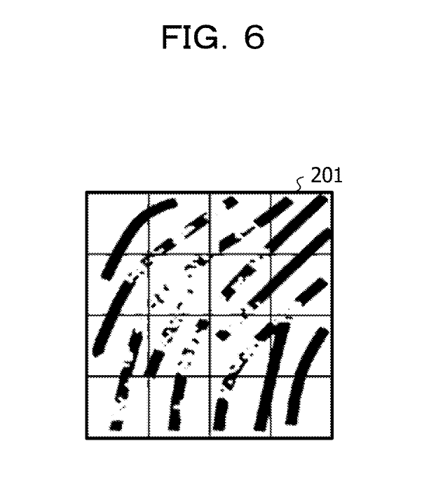

FIG. 6 is an example of a fingerprint image divided into a plurality of subregions.

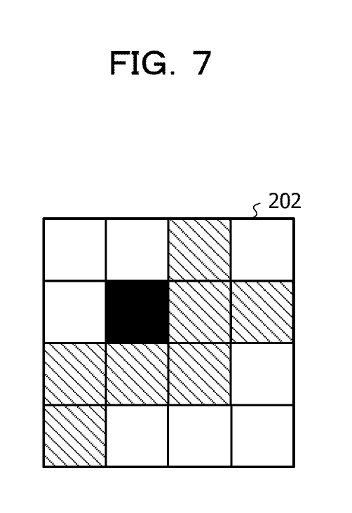

FIG. 7 is a diagram illustrating a determination result for the clarity of each subregion.

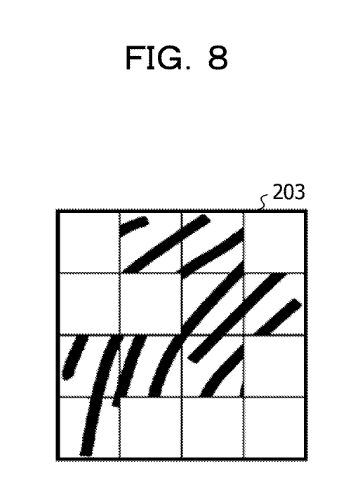

FIG. 8 is a diagram illustrating a clarified-ridge fingerprint image and mask areas.

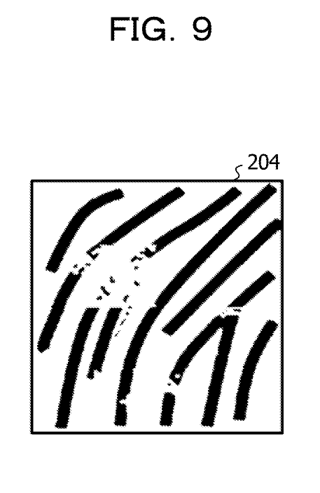

FIG. 9 is a diagram illustrating a corrected fingerprint image.

In step S501, the fingerprint input unit 121 detects unevenness of the surface of a finger of an authentication subject, generates a fingerprint image 201 representing a pattern of ridges (that is, a fingerprint) as illustrated in FIG. 5, and outputs the fingerprint image 201 to the processing unit 131. The fingerprint image acquisition unit 132 acquires the fingerprint image from the fingerprint input unit 121. An authentication subject inputs the ID of the authentication subject by using the ID input unit 111, and the ID input unit 111 acquires the input ID from the authentication subject and outputs the ID to the processing unit 131. The authentication unit 138 acquires the ID from the ID input unit 111.

In step S502, the dividing unit 133 divides the fingerprint image 201 into a plurality of subregions. For example, the dividing unit 133 divides the fingerprint image 201 into a total of 16 subregions, 4 subregions wide and 4 subregions long, as illustrated in FIG. 6. The clarity determining unit 134 calculates a clarity level indicating the clarity of the image of each subregion, in particular, a clarity level indicating the clarity of a fingerprint in each subregion. The clarity level is calculated as follows.

The clarity determining unit 134 calculates, in each pixel included in a subregion, the magnitude or orientation of a local edge and calculates the distribution of the magnitudes or orientations of edges. In a subregion with a clear ridge, the magnitudes or orientations of edges are consistent in the subregion, and therefore the distribution of the magnitudes or orientations of edges is small. In a subregion with an unclear ridge, edges with a variety of magnitudes or orientations are included, and therefore the distribution of the magnitudes or orientations of edges is large. In the embodiment, the reciprocal of the calculated distribution is assumed to be a clarity level C indicating the clarity of a fingerprint in the subregion. In the embodiment, a greater clarity level C indicates that the image of a subregion is clearer, and a smaller clarity level C indicates that the image of a subregion is more unclear. The clarity determining unit 134 calculates the distribution of the magnitudes or orientations of edges of each subregion to calculate the clarity level C of the subregion.

In step S503, the clarity determining unit 134 determines, in accordance with the calculated clarity level C of each subregion, whether the subregion is a clear area, a semi-clear area, or an unclear area. In particular, it is determined whether each subregion is a clear area, a semi-clear area, or an unclear area, as follows.

Thresholds Th1 and Th2 (Th1>Th2) are determined in advance. The clarity determining unit 134 determines that if the clarity level C of some subregion is greater than or equal to Th1, the subregion is a clear area. The clarity determining unit 134 determines that if the clarity level C of some subregion is less than Th1 and greater than or equal to Th2, the subregion is a semi-clear area. The clarity determining unit 134 determines that if the clarity level C of some subregion is less than Th2, the subregion is an unclear area.

As described above, the clarity determining unit 134 determines, in accordance with the clarity level C of each subregion, whether the subregion is a clear area, a semi-clear area, or an unclear area. Through the determination of clarity of each subregion by the clarity determining unit 134, a determination result 202 as illustrated in FIG. 7 is obtained. In the determination result 202 in FIG. 7, a subregion determined to be a clear area is represented in white, a subregion determined to be a semi-clear area is represented by slanted lines, and a subregion determined to be an unclear area is represented in black.

In step S504, the mask area setting unit 135 sets, among subregions determined to be unclear areas, at least one or more subregions as mask areas. For example, the mask area setting unit 135 may set, as mask areas, all of the subregions determined to be unclear areas. Furthermore, the mask area setting unit 135 may set, among subregions determined to be clear areas, at least one or more subregions as mask areas. For example, the mask area setting unit 135 may set, as mask areas, all of the subregions determined to be clear areas. For example, the mask area setting unit 135 may avoid setting, as a mask area, among subregions determined to be unclear areas, a subregion whose top, bottom, right, or left is adjacent to a semi-clear area. That is, the mask area setting unit 135 may set, as mask areas, among subregions determined to be unclear areas, at least one or more subregions other than a subregion whose top, bottom, right, or left side is adjacent to a semi-clear area.

In step S505, the fingerprint image correcting unit 136 corrects a fingerprint (in particular, the geometry of ridges) included in subregions other than the subregions set as mask areas (a ridge geometry correction process). It is assumed that all of the clear areas and the unclear areas are set as mask areas. That is, all of the semi-clear areas are subregions to be corrected. The fingerprint image correcting unit 136 corrects the geometry of ridges included in subregions other than the subregions set as mask areas in the fingerprint image 201 and generates a clarified-ridge fingerprint image 203. In the clarified-ridge fingerprint image 203 in FIG. 8, the geometry of ridges in semi-clear areas is corrected, and the mask areas are represented in white.

Correction of the geometry of ridges is, for example, performed as follows. The fingerprint image correcting unit 136 calculates the orientation of local ridges in a subregion to be corrected and applies an image filter having a smoothing effect toward the calculated local orientation and an edge enhancement effect to enhance ridges along the local orientation, thereby clarifying the ridges. One of the image filters having the effects mentioned above is an anisotropic shock filter. In the anisotropic shock filter, a smoothing effect toward a specific orientation and an edge enhancement effect are obtained by applying a shock filter after applying an anisotropic Gaussian filter having a strong smoothing effect toward a local ridge orientation.

In the ridge geometry correction process, when a local ridge orientation is not correctly calculated, ridges are enhanced in a false orientation, and, in some cases, false minutiae, which are endings and ridge bifurcations that are originally not present, occur in a clarified-ridge fingerprint image. That is, it may be considered that, in an unclear area where edge orientations are obscure, false minutiae are likely to occur. Accordingly, in the embodiment, at least some of the unclear areas are set as mask areas, and the ridge geometry correction process is not applied to the mask areas, which reduces the occurrence of false minutiae and improves the authentication accuracy.

In clear areas, the change in ridges between before and after the ridge geometry correction process is small, and therefore it is considered that the certainty in detection of minutiae does not change depending on whether the ridge geometry correction process is applied. That is, it is considered that the ridge geometry correction process for clear areas causes little change in authentication accuracy. Setting clear areas as mask areas may maintain authentication accuracy while reducing the ridge geometry correction process for clear areas.

In semi-clear areas where the orientations of edges are sufficiently clear and the change in ridges occurring upon application of the ridge geometry correction process is sufficiently large, the effect of the ridge geometry correction process is large. The semi-clear areas are considered to be suitable as subregions to be corrected.

Among clear areas or unclear areas, an area adjacent to a semi-clear area is considered to have properties close to those of the semi-clear area and is considered to obtain a large effect of the ridge geometry correction process. Accordingly, as described above, the mask area setting unit 135 may set, among clear areas or unclear areas, an area adjacent to a semi-clear area as a subregion to be corrected (not set as a mask area).

The fingerprint image correcting unit 136 combines the fingerprint image 201 with the clarified-ridge fingerprint image 203 to generate the corrected fingerprint image 204 as illustrated in FIG. 9. In particular, the fingerprint image correcting unit 136 calculates the pixel value of a pixel of the corrected fingerprint image 204 by using a weighted mean of the pixel value of a pixel of the fingerprint image 201 and the pixel value of a pixel of the clarified-ridge fingerprint image 203. The fingerprint image correcting unit 136 calculates the pixel value of each pixel of the corrected fingerprint image 204 by the following equation (1).

I(x,y)=(1−α(x,y))*O(x,y)+α(x,y)*E(x,y) (1)

In equation (1), O(x, y) denotes a pixel value at coordinates (x, y) in the fingerprint image 201, E(x, y) denotes a pixel value at coordinates (x, y) in the clarified-ridge fingerprint image 203, and I(x, y) denotes a pixel value at coordinates (x, y) in the corrected fingerprint image 204.

It is assumed that α(x, y) is a real number greater than or equal to 0 and less than or equal to 1, and α(x, y)=0 if the coordinates (x, y) are included in a mask area whereas otherwise α(x, y)≠0. That is, in the corrected fingerprint image 204, areas corresponding to mask areas are equal to those of the original fingerprint image 201, and the fingerprint in the other areas is a fingerprint to which the ridge geometry correction process is applied. At this point, since the greater the value of α(x, y), the stronger correction process is applied, α(x, y) may be determined depending on the area to which (x, y) belongs. For example, when it is set that a subregion that falls on the boundary between a clear area or an unclear area and a semi-clear area is not regarded as a mask area, α(x, y) may be determined such that α(x, y)=A1 if (x, y) is a semi-clear area whereas α(x, y)=A2(A1>A2) if (x, y) is a clear area or an unclear area. Thereby, variations in pixel value at the boundary between an area where correction is applied and a mask area may be smoothed. The corrected fingerprint image 204 in FIG. 9 represents the case where α(x, y)=1 if the coordinates (x, y) are not included in a mask area.

In step S506, the feature information extraction unit 137 extracts feature information from the corrected fingerprint image 204. The feature information is, for example, the positions of minutiae, such as an ending, which is a point at which a fingerprint ridge terminates, and a bifurcation, where a single ridge of a fingerprint splits into two ridges, and the relationships among their respective positions, and the like.

The authentication unit 138 compares the feature information of an authentication subject extracted by the feature information extraction unit 137 with the feature information associated with the ID, which is acquired from the ID input unit 111, included in the DB 142 and authenticates the authentication subject. In particular, the authentication unit 138 calculates the similarity between the feature information of an authentication subject and the feature information associated with the ID, which is acquired from the ID input unit 111, included in the DB 142 and, when the calculated similarity is greater than or equal to a threshold, the authentication unit 138 determines that the authentication subject is successfully authenticated. When authentication is successful, the authentication unit 138 performs predetermined processing, for example, such as unlocking of a door, unlocking of a smart phone, or notification of successful authentication. When the calculated similarity is less than the threshold, the authentication unit 138 determines that the authentication subject fails to be authenticated, and notifies the authentication subject to input again a fingerprint.

According to the biometric authentication apparatus in the embodiment, in a fingerprint image, an unclear area where the fingerprint clarity is low is not corrected, which may reduce the occurrence of false minutiae and improve the authentication accuracy.

According to the biometric authentication apparatus in the embodiment, an increase in false minutiae due to a correction process may be suppressed, compatibility with the past registration information may be maintained even when the correction process is applied, and consistent authentication may continue without reregistration of registration information.

According to the biometric authentication apparatus in the embodiment, in a fingerprint image, a semi-clear area with the fingerprint clarity at a medium level at which an appropriate correction is highly likely to be performed is corrected, which may clarify a fingerprint and improve authentication accuracy.

The fingerprint images illustrated in FIG. 1, FIG. 2, FIG. 5 and FIG. 6 are only examples of a biometric images, and the biometric authentication apparatus 101 may also perform biometric authentication by using other biometric images such as palm prints and intravenous images.

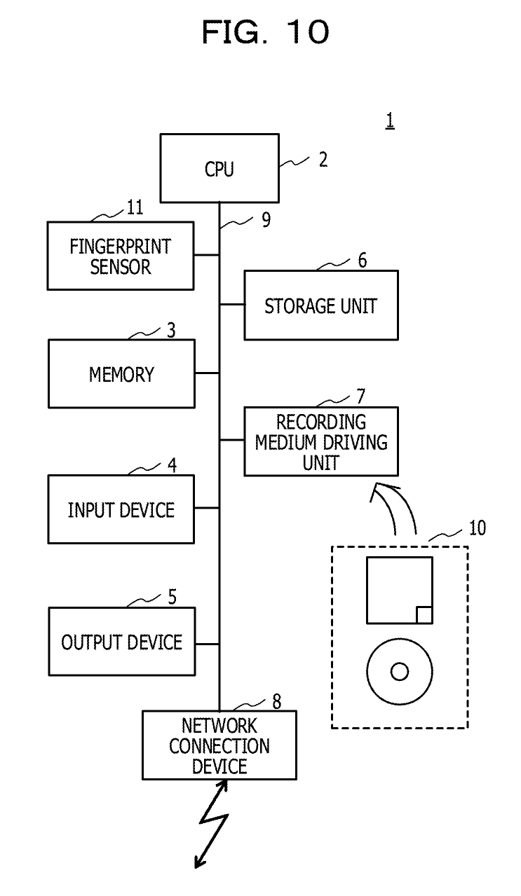

FIG. 10 illustrates an example of an information processing apparatus (computer). The biometric authentication apparatus 101 in the embodiment is able to be implemented, for example, by an information processing apparatus (computer) 1 as illustrated in FIG. 10.

The information processing apparatus 1 includes a central processing unit (CPU) 2, a memory 3, an input device 4, an output device 5, a storage unit 6, a recording medium driving unit 7, a network connection device 8, and a fingerprint sensor 11, which are coupled to each other via a bus 9.

The CPU 2 is a processor that controls the entire information processing apparatus 1. The CPU 2 operates as the fingerprint image acquisition unit 132, the dividing unit 133, the clarity determining unit 134, the mask area setting unit 135, the fingerprint image correcting unit 136, the feature information extraction unit 137, and the authentication unit 138.

The memory 3 is a memory, such as a read-only memory (ROM) or a random access memory (RAM), in which, during execution of a program, the program or data stored in the storage unit 6 (or a portable recording medium 10) is temporarily stored. The CPU 2 executes programs by using the memory 3, thereby executing the various processes described above.

The input device 4 is used for input of instructions and information from a user or operator, acquisition of data for use in the information processing apparatus 1, and the like. The input device 4 is, for example, a keyboard, a mouse, a touch panel, a card reader, or the like. The input device 4 corresponds to the ID input unit 111.

The output device 5 is a device that outputs an inquiry to a user or operator and a processing result and that operates under control by the CPU 2. The output device 5 is, for example, a display, a printer, or the like.

The storage unit 6 is, for example, a magnetic disk device, an optical disk device, a tape device, or the like. The information processing apparatus 1 stores the programs and data mentioned above in the storage unit 6 and, if required, retrieves them and uses them in the memory 3. The storage unit 6 corresponds to the storage unit 141.

The recording medium driving unit 7 drives the portable recording medium 10 and access the recorded content. As the portable recording medium 10, any computer-readable recording medium, such as a memory card, a flexible disk, a compact disk read-only memory (CD-ROM), an optical disk, or a magneto-optical disk, is used. A user stores the programs and data mentioned above in the portable recording medium 10 and, if required, reads them into the memory 3 to use them.

The network connection device 8 is a communication interface that is connected to any communication network, such as a local area network (LAN) or a wide area network (WAN), and that performs data conversion for communication. The network connection device 8 transmits data to a device connected via a communication network or receives data from a device connected via a communication network.

The fingerprint sensor 11 detects unevenness of the surface of a finger of an authentication subject and generates a fingerprint image representing a pattern of ridges (that is, a fingerprint). The fingerprint sensor 11 corresponds to the fingerprint input unit 121.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing apparatus comprising:
a memory; and
a processor coupled to the memory and configured to:
store registered feature information of a first biometric image which is acquired from a registrant;
divide a second biometric image which is acquired from an authentication subject into a plurality of areas;
calculate a clarity level indicating a clarity of an image of each of the plurality of areas;
set, among the plurality of areas, at least part of a first area that is an area with the clarity level less than a first threshold, as a mask area, in accordance with the clarity level of each of the plurality of areas;
generate a corrected biometric image by correcting an image of a second area other than the mask area among the plurality of areas;
extract feature information from the corrected biometric image; and
compare the registered feature information and the extracted feature information to perform authentication for the authentication subject.

2. The information processing apparatus according to claim 1, wherein the processor is further configured to set, among the plurality of areas, at least part of a third area with the clarity level greater than or equal to a second threshold greater than the first threshold, as the mask area.

3. The information processing apparatus according to claim 2, wherein the processor is configured to set, in the first area, at least part of an area other than an area adjacent to a fourth area with the clarity level less than the second threshold and greater than or equal to the first threshold, as the mask area.

4. The information processing apparatus according to claim 1, wherein the processor is configured to:
generate a clarified biometric image for the second area by correcting the image of the second area;
determine that, in the corrected biometric image, a pixel value of each pixel in an area corresponding to the mask area is a pixel value of each pixel in the mask area of the second biometric image; and
calculate, in the corrected biometric image, a pixel value of each pixel in an area corresponding to the second area by using a weighted mean of a pixel value of each pixel in the second area of the second biometric image and a pixel value of each pixel in an area corresponding to the second area of the clarified biometric image.

5. A biometric authentication method comprising:
storing, by a computer, registered feature information of a first biometric image which is acquired from a registrant;
dividing a second biometric image which is acquired from an authentication subject into a plurality of areas;
calculating a clarity level indicating a clarity of an image of each of the plurality of areas;
setting, among the plurality of areas, at least part of a first area that is an area with the clarity level less than a first threshold, as a mask area, in accordance with the clarity level of each of the plurality of areas;
generating a corrected biometric image by correcting an image of a second area other than the mask area among the plurality of areas;
extracting feature information from the corrected biometric image; and
comparing the registered feature information and the extracted feature information to perform authentication for the authentication subject.

6. The biometric authentication method according to claim 5, further comprising:
setting, among the plurality of areas, at least part of a third area with the clarity level greater than or equal to a second threshold greater than the first threshold, as the mask area.

7. The biometric authentication method according to claim 6, further comprising:
setting, in the first area, at least part of an area other than an area adjacent to a fourth area with the clarity level less than the second threshold and greater than or equal to the first threshold, as the mask area.

8. The biometric authentication method according to claim 5, further comprising:
generating a clarified biometric image for the second area by correcting the image of the second area;
determining that, in the corrected biometric image, a pixel value of each pixel in an area corresponding to the mask area is a pixel value of each pixel in the mask area of the second biometric image; and
calculating, in the corrected biometric image, a pixel value of each pixel in an area corresponding to the second area by using a weighted mean of a pixel value of each pixel in the second area of the second biometric image and a pixel value of each pixel in an area corresponding to the second area of the clarified biometric image.

9. A non-transitory computer-readable recording medium recording a biometric authentication program which causes a computer to execute a process, the process comprising:
storing registered feature information of a first biometric image which is acquired from a registrant;
dividing a second biometric image which is acquired from an authentication subject into a plurality of areas;
calculating a clarity level indicating a clarity of an image of each of the plurality of areas;
setting, among the plurality of areas, at least part of a first area that is an area with the clarity level less than a first threshold, as a mask area, in accordance with the clarity level of each of the plurality of areas;
generating a corrected biometric image by correcting an image of a second area other than the mask area among the plurality of areas;
extracting feature information from the corrected biometric image; and
comparing the registered feature information and the extracted feature information to perform authentication for the authentication subject.

10. The non-transitory computer-readable recording medium according to claim 9, further comprising:
setting, among the plurality of areas, at least part of a third area with the clarity level greater than or equal to a second threshold greater than the first threshold, as the mask area.

11. The non-transitory computer-readable recording medium according to claim 10, further comprising:
setting, in the first area, at least part of an area other than an area adjacent to a fourth area with the clarity level less than the second threshold and greater than or equal to the first threshold, as the mask area.

12. The non-transitory computer-readable recording medium according to claim 9, further comprising:
generating a clarified biometric image for the second area by correcting the image of the second area;
determining that, in the corrected biometric image, a pixel value of each pixel in an area corresponding to the mask area is a pixel value of each pixel in the mask area of the second biometric image; and
calculating, in the corrected biometric image, a pixel value of each pixel in an area corresponding to the second area by using a weighted mean of a pixel value of each pixel in the second area of the second biometric image and a pixel value of each pixel in an area corresponding to the second area of the clarified biometric image.
